(19) United States
(12) Patent Application Publication
(10) Pub. No.: US 2017/0161969 A1
(43) Pub. Date: Jun. 8, 2017

(54) SYSTEM AND METHOD FOR MODEL-BASED OPTIMIZATION OF SUBCOMPONENT SENSOR COMMUNICATIONS

(71) Applicant: The Boeing Company, Chicago, IL (US)

(72) Inventors: Greg A. Kimberly, Seattle, WA (US); David H. Jones, Bellevue, WA (US); Richard V. Robinson, Seattle, WA (US); Tyler J. Petri, Seattle, WA (US); Daniel J. Fogarty, Mukilteo, WA (US)

(21) Appl. No.: 14/960,823

(22) Filed: Dec. 7, 2015

(51) Int. Cl. G07C 5/08; G06F 9/445; G07C 5/02

(52) U.S. Cl. CPC G07C 5/08; G07C 5/02; G06F 9/445

(57) ABSTRACT

A system and method are disclosed for establishing hierarchal subcomponent sensor communication for a vehicle. A database includes information associated with a plurality of subcomponents having a sensor. A software modeling tool implements a safety model and a fault detection and isolation (FDI) model. The safety model determines a probability of a constraint being violated given a probability of failure of each subcomponent. The FDI model determines a probability associated with a risk exposure for known and unknown faults for each subcomponent. A processor identifies those subcomponent sensors that reduce risk-exposure based on probabilities generated using the safety model and FDI model and generates an output of a set of vehicle subcomponent sensors for connection to an vehicle communication system for communication at a higher level of hierarchy, such that the vehicle communication system can receive information indicative of a subcomponent fault and generate an alert about the fault.

### FIELD

This disclosure relates generally to a system and method for model-based optimization of subcomponent sensor communications.

### BACKGROUND

Many modern systems, particularly aircraft, are composed of component systems supplied by a wide array of suppliers. Each of these component systems is typically composed of a number of subcomponents that include sensors which are used during the normal operation of such subcomponent. Ideally, the output of each sensor would be coupled to the larger system of components, but the cost would be prohibitive because of the cost and complexity in coupling each sensor output to the larger system of components. Thus, the question of which of the sensors in each subcomponent should be coupled to the larger system of components can be a difficult coordination question.

Accordingly, there is a need for a system and method for model-based optimization of subcomponent sensor communications which aids in determining which of the sensors in each subcomponent is coupled to the larger system of components to identify subcomponent faults.

### SUMMARY

In a first aspect, a system for establishing hierarchal subcomponent sensor communication for a vehicle. The system includes a processor, a database, and a memory. The database includes information associated with a plurality of subcomponents for the vehicle that each include at least one sensor that outputs information related to the subcomponent. The memory has at least one executable software modeling tool stored therein for implementing a safety model and a fault detection and isolation (FDI) model. The safety model, when executed by the processor, is configured to determine a probability of a constraint being violated given a probability of failure of each subcomponent. The FDI model, when executed by the processor is configured to determine a probability associated with a risk exposure for known and unknown possible faults for each of the plurality of subcomponents. The memory also has a set of instructions executable by the processor stored therein to identify those subcomponent sensors that reduce risk-exposure based on probabilities generated using the safety model and FDI model, through communication of the sensor output to a vehicle communication system, so as to provide information indicative of a known fault to provide an alert. Finally, the processor is configured, based on additional instructions stored in the memory, to generate an output of a set of vehicle subcomponent sensors for connection to an vehicle communication system for providing sensor communication at a higher level of hierarchy outside of the vehicle subcomponent, such that the vehicle communication system can receive information indicative of a subcomponent fault whereby an alert is generated about the vehicle subcomponent fault.

In a second aspect, a computer-implemented method for establishing hierarchal subcomponent sensor communication for an aircraft. First, using a modeling tool to generate a safety model, a probability of a constraint being violated given a probability of failure of each subcomponent is determined. Next, using a modeling tool to generate a fault detection and isolation (FDI) model, a probability associated with a risk exposure for known and unknown possible faults for each of the plurality of subcomponents is determined. Then, those subcomponent sensors that reduce risk-exposure based on probabilities generated using the safety model and FDI model, through communication of the sensor output to an aircraft communication system, so as to provide information indicative of a known possible fault to provide an alert are identified. Finally an output is generated of a set of subcomponent sensors for connection to an aircraft communication system for providing sensor communication at a higher level of hierarchy outside of the subcomponent itself, such that the aircraft communication system can receive information indicative of a subcomponent fault whereby an alert is generated to alert a crew member of the subcomponent fault.

In a third aspect, a system for establishing hierarchal subcomponent sensor communication for an aircraft. The system includes a processor, a database and a memory. The database includes information associated with a plurality of aircraft subcomponents that each include at least one sensor that outputs information related to the aircraft subcomponent. The memory has at least one executable software modeling tool for implementing a safety model and a fault detection and isolation (FDI) model stored therein. The safety model, when executed by the processor, is configured to determine a probability of a constraint being violated given a probability of failure of each aircraft subcomponent. The FDI model, when executed by the processor is configured to determine a probability associated with a risk exposure for known and unknown possible faults for each of the plurality of aircraft subcomponents. The memory also includes a set of instructions executable by the processor to identify those aircraft subcomponent sensors that reduce risk-exposure based on probabilities generated using the safety model and FDI model, through communication of the sensor output to an aircraft communication system, so as to provide information indicative of a known possible fault to provide an alert. The processor is configured, based on additional instructions stored in the memory, to generate an output of a set of aircraft subcomponent sensors for connection to an aircraft communication system for providing sensor communication at a higher level of hierarchy outside of the aircraft subcomponent, such that the aircraft communication system can receive information indicative of a subcomponent fault whereby an alert is generated about the aircraft subcomponent fault.

The features, functions, and advantages that have been discussed can be achieved independently in various embodiments or may be combined in yet other embodiments, further details of which can be seen with reference to the following description and drawings.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is a block diagram of a system of systems showing the hierarchy of component systems in a top level system, subcomponents in each component system, and sensors in each subcomponent;

FIG. 2 is a flowchart showing the generation of a safety model according to an aspect of the present disclosure;

FIG. 3 is a flowchart showing the generation of a subcomponent sensor configuration set according to a further aspect of the present disclosure; and

FIG. 4 is a block diagram of a system for processing the subcomponent sensor configuration set based on the safety model and the fault detection and isolation model according to a still further aspect of the present disclosure.

### DETAILED DESCRIPTION

In the present disclosure, like reference numbers refer to like elements throughout the drawings, which illustrate various exemplary embodiments of the present disclosure.

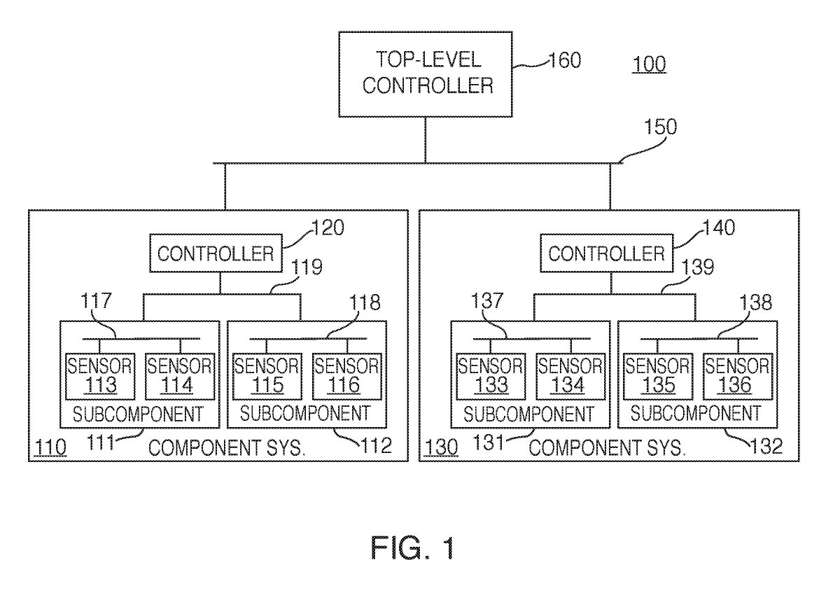

Referring now to FIG. 1, a typical vehicle such as an aircraft includes a complex system of systems (SoS) 100 that includes numerous component systems 110, 130 etc. and corresponding subcomponent systems 111, 112, 131, 132 organized in hierarchical form. Although one of ordinary skill in the art will readily recognize that a complex system of systems will ordinarily include many more component systems than the two component systems 110, 130 shown in FIG. 1, only two such systems are shown therein for brevity. Each component system 110, 130 in a system of systems 100 typically includes a number of subcomponents. As shown in FIG. 1, component system 110 includes two subcomponents 111, 112 and component system 130 includes subcomponents 131, 132.

Subcomponents 111 and 112 may each include internal sensors 113, 114 and sensors 115, 116, respectively that are used for monitoring a process, event or environmental characteristic that is related to the function of the particular subcomponent. For component 111, each sensor 113, 114 may be coupled to an internal processor (not shown) via a network 117. In some cases, the output of each sensor 113, 114 may be in analog form and separate links may be provided from each sensor 113, 114 to the internal processor. In the same manner, for component 112, each sensor 115, 116 may be coupled to an internal processor (not shown) via a network 118. In some cases, the output of one or both of sensors 115, 116 may be in analog form and separate links may be provided from one or both of sensors 115, 116 to the internal processor. Each subcomponent 111, 112 is coupled to a controller 120 via a link 119 via an interface not shown in FIG. 1. As one of ordinary skill in the art will readily recognize, although each subcomponent 111, 112 is shown with two sensors, in some cases a subcomponent may include more than two sensors and in other cases a subcomponent may include only a single sensor.

Subcomponents 131 and 132 may each include internal sensors 133, 134 and sensors 135, 136, respectively that are used for monitoring a process, event or environmental characteristic that is related to the function of the particular subcomponent. For component 131, each sensor 133, 134 may be coupled to an internal processor (not shown) via a network 137. In some cases, the output of each sensor 133, 134 may be in analog form and separate links may be provided from each sensor 133, 134 to the internal processor. Each separate link may be a hard-wired link or a wireless link. In the same manner, for component 132, each sensor 135, 136 may be coupled to an internal processor (not shown) via a network 138. In some cases, the output of one or both of sensors 135, 136 may be in analog form and separate links may be provided from one or both of sensors 135, 136 to the internal processor. Each subcomponent 131, 132 is coupled to a controller 140 via a link 139 via an interface not shown in FIG. 1. As one of ordinary skill in the art will readily recognize, although each subcomponent 131, 132 is shown with two sensors, in some cases a subcomponent may include more than two sensors and in other cases a subcomponent may include only a single sensor.

In a typical complex system of systems, each component system 110, 130 is also coupled to a higher top-level controller 160 via, for example, a network 150. Top-level controller 160 may only receive status signals from each of the component systems 110, 130, or top-level controller 160 may also provide operative signals to one or more of the component systems 110, 130. However, since each component system 110, 130 will typically include numerous subcomponents (i.e., many more than just the two shown in FIG. 1), it is cost-prohibitive for each component 110, 130 to be designed to provide, for example as a status message, information about the status of the output of each sensor 113 to 116 and 133 to 136 in signals provided to top-level controller 160.

To determine an optimum configuration for system of systems 100 in terms of identifying the particular sensors among the group of sensors 113 to 116, 133 to 136 that are coupled to top-level controller 160 (directly or via a status messages, etc.), the system disclosed herein combines two different types of system models—a formal Safety Model for each subcomponent and a formal Fault Detection and Isolation (FDI) model, that are used to process Subcomponent Sensor Configuration Sets. This type of system has been found to provide an analytical answer quickly and effectively based on issues of certification, cost, and effect upon potential maintenance procedures.

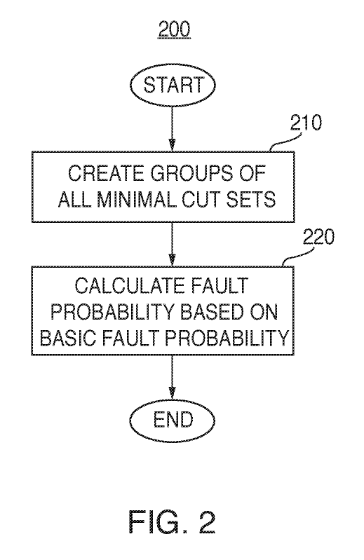

The Safety Model relates the effective probability of the occurrence of a top-level event to the probabilities of failure for each of the system components by modeling how the system operates both under normal conditions and failure conditions. The Safety Model consists of the following elements: (1) a behavioral model of a system consisting of components defined as finite state machines that send each other signals; (2) a set of failure definitions for the components; and (3) a set of desired constraints upon the behavior of that system expressed as a set of logical statements, the desired constraints encoding the occurrence of undesired events. In operation, the Safety Model allows the calculation of a probability of a constraint being violated given a probability of failure of each component. In particular, the process of generating a Safety model, shown in the flowchart 200 in FIG. 2, includes two key steps. First, groups of all minimal cut sets are constructed at step 210. A minimal cut set is a set of faults that lead to a top level event, such as the degradation of a desirable functionality. Second, the corresponding fault probability (i.e. a probability of reaching the top level event) is calculated based on the probabilities for the basic faults at step 220.

The Fault Detection and Isolation (FDI) Model identifies the exposure time for a given failure mode of a component given a particular sensor configuration. Given a set of components, a set of possible failure modes for each of the components, and a set of sensors each of which can sense some subset of the possible failure modes of a subset of each of the components, the FDIR model can tell you which sets of component failures can be detected (the FDI system can identify that one of a set of component failures has occurred) and furthermore isolated (a specific failure of a specific component has occurred). The FDI model allows a determination of a probability associated with a risk exposure for known and unknown possible faults for each of the plurality of subcomponents.

The Subcomponent Sensor Configuration Sets are a collection of sets identifying the particular sensors within the set of all sensors existing within all of the subcomponents within a particular system of systems which are to be coupled to the top level controller 160. As discussed above, a sensor in a subcomponent may be coupled to the top level controller 160 directly or the subcomponent may be configured to output a status message that is supplied to the top level controller 160 which includes information about the status (e.g., output) of such sensor.

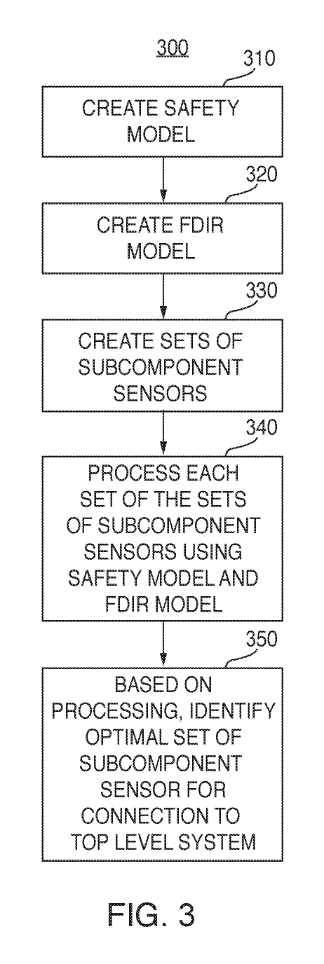

Referring now to FIG. 3, an aircraft system of systems may be analyzed to determine an optimum set of subcomponent sensors for coupling to the top-level system (e.g., the aircraft communications system) by first generating a safety model (step 310) and an FDI model (step 320). Next, at step 330, sets of subcomponent sensors are created based on the complete set of subcomponent sensors within all the subcomponents in the aircraft system of systems. For example, the complete sets of subcomponent sensors may cover every possible perturbation of the complete set of subcomponent sensors within all the subcomponents in the aircraft system of systems, or in some cases a reduced number of perturbations may be provided when a priori knowledge of certain of the sensors is available (e.g., it is known that a particular sensor should always be coupled to the top-level system). Once, all of the sets are identified, each set is processed using the Safety Model and the FDI Model (step 340) and the results are analyzed (step 350) to identify an optimized set among the sets for connection to the top-level system. Optimization can occur via a variety of metrics. For example, one metric would be to choose the least costly set of sensors that would constrain the latency of failures that participate in certification-sensitive top-level events to a level that will allow the system as a whole to be certified. Another metric might relate each sensor set to a relative cost and duration of total system maintenance.

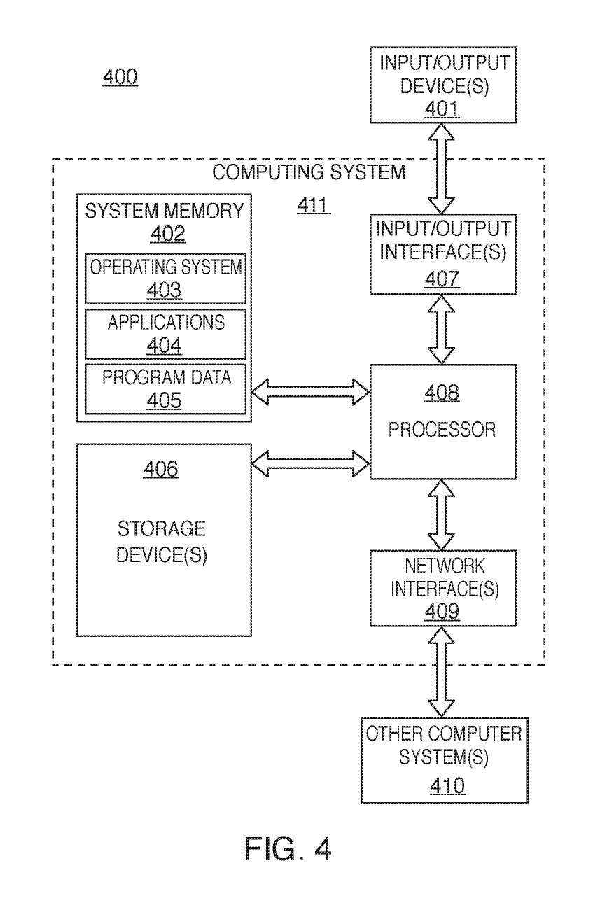

FIG. 4 is a block diagram of a system 400 operable to implement the methods disclosed herein. A computing system 411 includes at least one processor 408 which communicates with a system memory 402, one or more storage devices 406, one or more input/output devices 401, and one or more network interfaces 409 through which the computing system 411 may communicate with one or more other computer systems 410.

The system memory 402 may include volatile memory devices, such as random access memory (RAM) devices and nonvolatile memory devices such as read-only memory (ROM), programmable read-only memory, and flash memory. The system memory 402 typically includes an operating system 403, which may include a basic/input output system for booting the computing system 411 as well as a full operating system to enable the computing system 411 to interact with users, other programs, and other computer systems 410. The system memory 402 also typically includes one or more application programs 404, including modeling programs used to implement the Safety Model and the FDI model. The system memory 402 also may include program data 505.

The processor 411 may also communicate with one or more storage devices 406. The storage devices 406 may include nonvolatile storage devices such as magnetic disks, optical disks, or flash memory devices. Storage device 406 may be used to store the information necessary for the implementation of the Safety Model and the FIDR model by the associated modeling programs) and may also store information about the sets of subcomponent sensors. In some cases, the information about the sets of subcomponent sensors may be implemented in a database stored within storage device 406.

The processor 408 communicates via one or more input/output interfaces 407 with one or more input/output devices 401 that enable the computing device 411 to interact with a user. The input/output devices 401 may include keyboards, pointing devices, microphones, speakers, and displays. The processor 408 may also communicate with one or more network interfaces 409 that enable the computing device 411 to communicate with other computing systems 410.

It is important to note that not all of the components or devices illustrated in FIG. 4 or otherwise described in the previous paragraphs may be necessary to support implementations of the present disclosure. In a presently preferred embodiment, system 400 is used to establish hierarchal subcomponent sensor communication for an aircraft based on the method shown in FIG. 3. In particular, a database may be stored in storage device 406 which includes information associated with a plurality of aircraft subcomponents that each include at least one sensor that outputs information related to the aircraft subcomponent. One or more executable software modeling tools for implementing a safety model and an FDI model may be included within program data 405. These software modeling tools, which when executed by the processor, are configured to determine a probability of a constraint being violated given a probability of failure of each aircraft subcomponent (for the safety model) and a probability associated with a risk exposure for known and unknown possible faults for each of the plurality of aircraft subcomponents (for the FDI model). In addition, program data 405 may include a set of instructions executable by the processor to identify those aircraft subcomponent sensors that reduce risk-exposure on probabilities generated using the safety model and FDI model, through communication of the sensor output to an aircraft communication system, so as to provide information indicative of a known possible fault to provide an alert. Finally, processor 408 may be configured to generate, based on additional instructions stored in memory 405, an output of a set of aircraft subcomponent sensors for connection to an aircraft communication system for providing sensor communication at a higher level of hierarchy outside of the aircraft subcomponent, such that the aircraft communication system can receive information indicative of a subcomponent fault whereby an alert is generated to alert a crew member of the subcomponent fault.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

What is claimed is:

1. A system (400) for establishing hierarchal subcomponent sensor communication for a vehicle, comprising:
a processor (408);
a database in a storage device (406) including information associated with a plurality of subcomponents for the vehicle that each include at least one sensor that outputs information related to the subcomponent;
a memory (402) having stored therein:
at least one executable software modeling tool for implementing a safety model and a fault detection and isolation (FDI) model, the safety model, when executed by the processor, is configured to determine a probability of a constraint being violated given a probability of failure of each subcomponent, the FDI model, when executed by the processor, is configured to determine a probability associated with a risk exposure for known and unknown possible faults for each of the plurality of subcomponents, and
a set of instructions executable by the processor to identify those subcomponent sensors that reduce risk-exposure based on probabilities generated using the safety model and FDI model, through communication of the sensor output to a vehicle communication system, so as to provide information indicative of a known fault to provide an alert; and
wherein the processor is configured, based on additional instructions stored in the memory, to generate an output of a set of vehicle subcomponent sensors for connection to an vehicle communication system for providing sensor communication at a higher level of hierarchy outside of the vehicle subcomponent, such that the vehicle communication system can receive information indicative of a subcomponent fault whereby an alert is about the vehicle subcomponent fault.

2. The system of claim 1, wherein the safety model is generated, at least in part, by creating groups of all minimal cut sets for each subcomponent.

3. The system of claim 1, wherein the safety model is generated, in part, by calculating a corresponding fault probability for each of a set of minimal cut sets.

4. The system of claim 1, wherein the safety model comprises a behavior model of each subcomponent, a set of failure definitions for each subcomponent, and set of desired constraints of behavior of each subcomponent.

5. The system of claim 1, wherein the FDI model identifies an exposure time for a given failure mode of a subcomponent for a given sensor configuration.

6. The system of claim 1, wherein the information in the database comprises a subcomponent sensor configuration set for the vehicle.

7. The system of claim 1, wherein the processor is configured to generate the output of a set of vehicle subcomponent sensors based on a predetermined metric.

8. A computer-implemented method for establishing hierarchal subcomponent sensor communication for a vehicle, comprising:
determining, using a modeling tool to generate a safety model, a probability of a constraint being violated given a probability of failure of each subcomponent;
determining, using a modeling tool to generate a fault detection and isolation (FDI) model, a probability associated with a risk exposure for known and unknown possible faults for each of the plurality of subcomponents;
identifying those subcomponent sensors that reduce risk-exposure based on probabilities generated using the safety model and FDI model, through communication of the sensor output to a vehicle communication system, so as to provide information indicative of a known fault to provide an alert; and
generating an output of a set of subcomponent sensors for connection to a vehicle communication system for providing sensor communication at a higher level of hierarchy outside of the subcomponent itself, such that the vehicle communication system can receive information indicative of a subcomponent fault whereby an alert is generated to alert about the subcomponent fault.

9. The method of claim 8, wherein the safety model is generated, in part, by creating groups of all minimal cut sets for each subcomponent.

10. The method of claim 8, wherein the safety model is generated, in part, by calculating a corresponding fault probability for each of a set of minimal cut sets.

11. The method of claim 8, wherein the safety model comprises a behavior model of each subcomponent, a set of failure definitions for each subcomponent, and set of desired constraints of behavior of each subcomponent.

12. The method of claim 8, wherein the FDI model identifies an exposure time for a given failure mode of a subcomponent for a given sensor configuration.

13. The method of claim 8, wherein the output of a set of vehicle subcomponent sensors is generated, in part, based on a predetermined metric.

14. A system (400) for establishing hierarchal subcomponent sensor communication for an aircraft, comprising:
a processor (408);
a database in a storage device (406) including information associated with a plurality of aircraft subcomponents that each include at least one sensor that outputs information related to the aircraft subcomponent;
a memory (402) having stored therein:
at least one executable software modeling tool for implementing a safety model and a fault detection and isolation (FDI) model, the safety model, when executed by the processor, is configured to determine a probability of a constraint being violated given a probability of failure of each aircraft subcomponent, the FDI model, when executed by the processor is configured to determine a probability associated with a risk exposure for known and unknown possible faults for each of the plurality of aircraft subcomponents, and
a set of instructions executable by the processor to identify those aircraft subcomponent sensors that reduce risk-exposure based on probabilities generated using the safety model and FDI model, through communication of the sensor output to an aircraft communication system, so as to provide information indicative of a known fault to provide an alert; and
wherein the processor is configured, based on additional instructions stored in the memory, to generate an output of a set of aircraft subcomponent sensors for connection to an aircraft communication system for providing sensor communication at a higher level of hierarchy outside of the aircraft subcomponent, such that the aircraft communication system can receive information indicative of a subcomponent fault whereby an alert is generated to alert a crew member of the aircraft subcomponent fault.

15. The system of claim 14, wherein the safety model is generated, at least in part, by creating groups of all minimal cut sets for each subcomponent.

16. The system of claim 14, wherein the safety model is generated, in part, by calculating a corresponding fault probability for each of a set of minimal cut sets.

17. The system of claim 14, wherein the safety model comprises a behavior model of each subcomponent, a set of failure definitions for each subcomponent, and set of desired constraints of behavior of each subcomponent.

18. The system of claim 14, wherein the FDI model identifies an exposure time for a given failure mode of a subcomponent for a given sensor configuration.

19. The system of claim 14, wherein the information in the database comprises a subcomponent sensor configuration set for the aircraft.

20. The system of claim 14, wherein the processor is configured to generate the output of a set of aircraft subcomponent sensors based on a predetermined metric.
